(19) United States
(12) Patent Application Publication
(10) Pub. No.: US 2023/0215404 A1
(43) Pub. Date: Jul. 6, 2023

(54) MUSICAL INSTRUMENT HAVING MULTIPLE SOUND BOARDS

(71) Applicant: Kwang Rim LEE, Yongin-Shi, Kyoungki-do (KR)

(72) Inventor: Kwang Rim LEE, Yongin-Shi, Kyoungki-do (KR)

(21) Appl. No.: 17/927,711

(22) PCT Filed: May 31, 2021
(86) PCT No.: PCT/KR2021/006746

§ 371 Date: Nov. 24, 2022

(30) Foreign Application Priority Data
Jun. 1, 2020 (KR) 10-2020-0065740

(51) Int. Cl. G10D 3/02; G10D 1/08

(52) U.S. Cl. CPC G10D 3/02; G10D 1/08

(57) ABSTRACT

A musical instrument, which is one of musical instruments generating a sound using a sound board, the musical instrument designed to generate resonance of abundant and various sounds by separating a resonance space into several parts by simultaneously using several sound boards to one musical instrument, to enable a magnificent and wide-spectrum performance such as an orchestra as one musical instrument by implementing a high-level sound effect required when playing the musical instrument, such as not only an increase of a volume, but generation of an individual tone, depth of a sound, and a stereoscopic sense of a sound by applying various and new elements to each of several sound boards.

### TECHNICAL FIELD

The present invention relates to a structural design for musical instruments (stringed instruments, rubbed string instruments, a guitar, guitar-group instruments, a violin, violin-group instruments, a piano, Chinese fiddle-group instruments, etc.) expressing sound using a sound board (wood, metal, synthetic resin, or leather), and more specifically, to a structural design of a musical instrument that greatly increases the sound of musical instrument and maximizes a sound effect when a musical instrument is played by simultaneously using several sound boards specially designed by the present invention in one musical instrument, that maximizes a sound effect to enable a beautiful and magnificent performance by combining several elements such as an inclined sound board 4, a reduced sound board 5, a three-dimensional bridge 7, a three-dimensional bridge 8 with a sound amplifier, a trumpet-type resonance pipe 18, a sound board groove 21, and a three-dimensional wound board 23, which are instrument design elements newly designed by the present invention such that a musical expression range is increased, whereby it is possible to enable a performance like a magnificent and broad-spectrum orchestras through one musical instrument.

### BACKGROUND ART

Existing musical instruments that generate a sound using sound boards are designed to use only one or two sound boards, so they have limitation in generating a large sound when they are played. Accordingly, their volume is too small when they are played in wide halls or played with an orchestra, etc., so there is a problem that the flow of music is disconnected, for example, a sound does not sufficiently travel to a far audience or melodies of a solo musical instrument is disconnected by being covered with the sounds of other musical instrument, which causes a problem with musical expression in many cases. Further due to the simple structures, they can generate only sounds with simple qualities, they are not enough to implement high-level sound effects, that is, a sufficient volume, a stereoscopic sense, colorful and aesthetic tone colors, sufficient overtones, sufficient resonance, depth of a sound, and various and individual tones, so they cannot generate a sufficient sound effect. Accordingly, there is a problem that they are relatively simply played and have limitation in expressing more beautiful, magnificent, and wide music.

### PRIOR ART DOCUMENT

Non-Patent Document 0001

Acoustic Guitar, Hal Leonard Coporation Teja Gerken, Michale Simons, Frank Ford, Richard Johnston ISBN 978-0-634-07920-7, Pages 154-155, Cross or X-bracing

Non-Patent Document 0002

Violin-making, Alpha Editions Edward Heron-Alien ISBN 35 978-93-89465-13-6, Pages 147˜154, The Interior Of The Violin

### DISCLOSURE

The present invention is characterized by musical instruments that generate a sound using sound boards, by designing a musical instrument to sufficiently increase the volume of the musical instrument by using several sound boards specially designed by the present invention and to maximize a sufficient volume, a stereoscopic sense, colorful and beautiful tone colors, sufficient overtones, sufficient resonance, depth of a sound, individual tones, and various tones, which are sound effects required for good musical instruments when musical instruments are played, by combining various new design elements according to the present invention so that the musical instrument can show wide musical expression and can show magnificent and wide spectrums as one musical instrument when the musical instrument is played. As a method of the object, the present invention is characterized in that several sound boards specially designed by the present invention and newly designed elements, that is, several elements such as an inclined sound board 4, a reduced sound board 5, a sound amplifier, a three-dimensional bridge 7, a three-dimensional bridge 8 with a sound amplifier, a trumpet-type resonance pipe 18, a sound board groove 21, and a three-dimensional wound board 23 are combined and simultaneously used in one musical instrument so that a sound effect can be maximized, musical expression is widened, a magnificent and wide-spectrum performance is possible as one musical instrument like an orchestra.

In more detail, elements and effects of the present invention are described as follows with reference to the accompanying drawings.

The present invention, as in FIG. 1, uses several special sound boards simultaneously in one musical instrument, applies the structural elements of special sound boards designed by the present invention to the sound boards, and combines other newly designed elements, whereby it is possible to achieve wide musical expression when playing the musical instrument through an increase of a volume, a stereoscopic sense of a sound, and individual tones from several sound boards having various structure because the several sound boards are simultaneously vibrated when the musical instrument is played.

FIG. 2 shows the structure of a musical instrument of the related art, in which a sound is generated in only one resonance space and the structure is simple, so the tone is also simple, whereby a performance is unavoidably monotonous.

As shown in FIG. 3, the inclined sound board 4 according to the present invention is inclined unlike other sound boards, so the sound wave of a sound smoothly travels and is mixed and resonated well with the sound waves from other sound boards, which results is sound effects such as a sense of sufficient resonance, expression of an individual tone, etc. Further, the inclined sound board is diagonally formed across a resonance space in the musical instrument, so the length thereof and the area of the sound boards are increased, whereby can result in an increase in volume of the musical instrument.

The reduced sound board 5 is configured such that the sound board is reduced with a size not the same as those of other sound boards, and when the musical instrument generates a sound, a portion of the sound board resonates a sound and the space of the other portion transmits a sound and accelerates and diversifies the flow of a sound wave so that a tone is changed, a sense of resonance is improved, and a stereoscopic sense of a sound is achieved by harmonizing with several sound boards like the waveform principle view of FIG. 4. FIG. 4 is a view showing a sound waveform principle, in which (A) is a view showing the form of a sound wave when only one sound board is used and (B) is a view illustrating the principle of stereology of sound in which sound waves of a musical instrument designed with three sound boards are combined, thereby achieving a stereoscopic result. Further, sound resonance is easily generated when the reduced sound board 5 generates a sound because the sound board is light, which makes it easy to play the musical instrument.

The three-dimensional bridge 8 with a sound amplifier is configured such that as in FIG. 5, a sound amplifier 17 composed of several partition ribs 16 is formed inside under the sound board and is integrated with a three-dimensional bridge 7 having a shape that is efficient to transmit sound vibration to sound boards thereunder. In order to simultaneously vibrate all of several sound boards with one plucking when a musical instrument, a large amount of energy is required, so it is required to greatly amplify the sound vibration of a forward sound board and transmit the sound vibration to the next sound board. According to the structure of the sound amplifier 17, the rigidity of the sound board is increased by installing several partition ribs 16 therein, and the partition ribs are covered to be sealed by a cover plate 26 made of wood or synthetic resin in a thin plate shape, so many resonance independent resonance spaces are formed and individually resonate, whereby sound vibration is greatly amplified. Further, the sound amplifier 17 is integrated with the hollow three-dimensional bridge 7 having a shape that is efficient to transmit sound vibration, whereby it is possible to achieve a synergy effect.

The three-dimensional bridge 7 is configured such that the vibration energy of a forward board should be maximally transmitted to the next sound board by minimizing a loss of energy so that several sound boards simultaneously generate a sound. As shown in FIG. 3, the three-dimensional bridge 7 is formed in a three-dimensional rectangular shape that is efficient for sound vibration by connecting a series of sound board using wood or synthetic resin, which is hollow and strong, to reduce weight, and a bridge core 14 is made of a slight more rigid and stronger material right under a position where strings are held so that sound vibration can be directly transmitted to sound boards thereunder, whereby sound vibration energy can be transmitted well to the sound boards.

The three-dimensional sound board 23 is configured such that two sound boards are combined into a single one by the partition ribs 16, and as the two sound boards are combined into a single one, a sound board having high rigidity is obtained, so a dynamic sound can be generated, a three-dimensional tone is generated because the sounds from the two sound boards are combined into one, and a resonance effect and a volume are increased by a set of many rectangular sealed resonance spaces formed by the partition ribs 16.

The trumpet-type resonance pipe 18 is configured such that when a sound generated in a forward resonance space travels to the next resonance space, a trumpet-type resonance pipe having a narrow inlet and a wide outlet is formed in a sound board like a cone for cheering, so that a wound wave is enlarged while traveling outside due to diffraction of a sound, as in FIG. 8, whereby a volume is increased. As in FIG. 3, several trumpet-type resonance pipes are formed in one sound proof and are made of very thin and light wood or synthetic resin to maximally prevent reduction of vibration energy of the sound board. An exit having the same size as a sound hole 9 is fitted in the sound hole and a narrow waist is fixed to a lower sound board, so sounds from several sound boards are amplified and sent outside, thereby enabling a performance with a magnificent volume. FIG. 8 (A) is the structure of a trumpet-type resonance pipe 18 formed in a sound board and FIG. 8 (B) is the structure of a trumpet-type resonance pipe 18 formed in the sound hole 9.

In general, a method of attaching a protruding frame 15 to the rear surface of a sound board (bracing) is used for musical instruments employing sound boards in order to tune the musical instruments. On the contrary, the groove of a sound board (minus bracing) 21 according to the present invention is configured such that as in FIG. 9, a series of concave grooves is engraved on a sound board and is covered with a thin and light plate (cover plate 26), whereby the space is sealed. Accordingly, the weight of the sound board is reduced and the rigidity is increased, so the resonance effect is increased, whereby it is possible to increase the volume, generate a sound with a strong tone, and easily tune a musical instrument. Manufacturers of musical instruments always take pains to manufacture musical instruments that can resonate well even with a small amount of energy by reducing the weight of sound boards, and frequently use a method of decreasing the weight of a sound board as a solution. However, materials (wood, synthetic resin, etc.) of sound boards can react well to sound vibration and musically resonate only when they have a thickness or a limit thickness for the characteristics of the materials. When a sound board is manufacture excessively thin over the limit thickness, intervals are unstable or the tone is not beautiful, and a problem is generated even with the durability. In the present invention, a minimum thickness is used within a range that can make the best use of the characteristic of the material of a sound board, a space is formed by forming a groove in the sound board, and the space is covered with a thin cover plate 26 made of a light and strong material, whereby the weight of the sound board is decreased and the rigidity of the sound board is increased so that a performance with a large volume is possible.

Further, by applying bracing that is a general method of attaching a frame in the related art to the cover plat 26, it is possible to generate an individual tone and a stronger tone.

The shape of the groove, as in FIG. 1, may be a spiral shape (A), a lattice shape (s), and an arc shape (C), and may be designed infinite shapes in accordance with sound personalities that manufacturer want.

A musical instrument that can be designed by combining various elements according to the present invention can be applied to all kinds of musical instruments representatively generating a sound using guitar-group instruments, violin-group instruments, and a piano.

FIG. 11 is an example in which the present invention is applied to a violin and FIGS. 12 and 13 are examples in which the present invention is applied to a piano.

As described above, a musical instrument according to the present invention is designed such that several sound boards having special structures are combined with other newly designed several elements to increase the volume of the musical instrument and maximize the wound effect, thereby enabling a magnificent and wide performance like an orchestra by one musical instrument.

### DESCRIPTION OF DRAWINGS

FIG. 1 is a cross-sectional perspective view showing variously configured internal structure of a musical instrument according to the present invention.

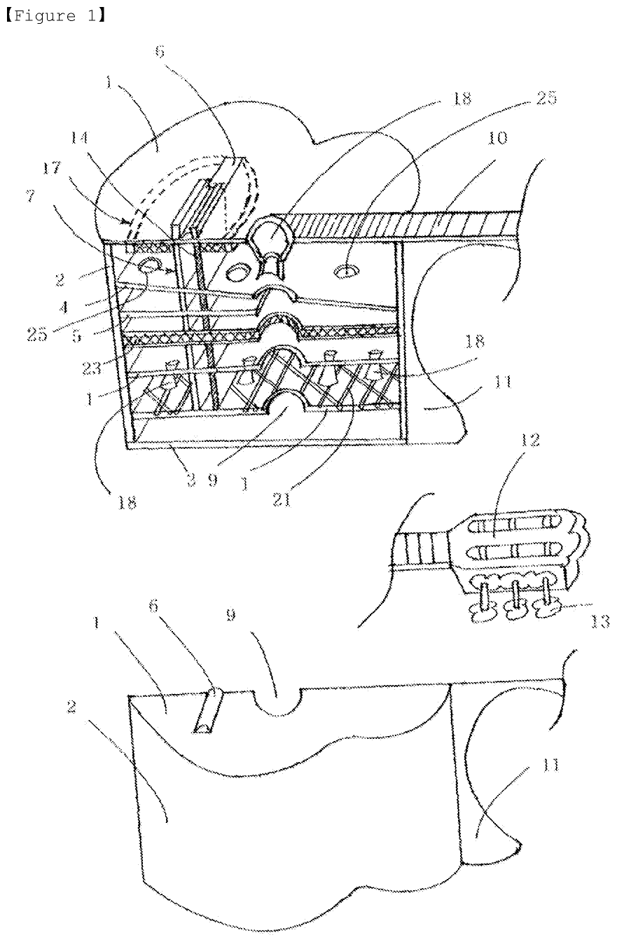

FIG. 2 is a cross-sectional perspective view showing the inside of a musical instrument of the related art.

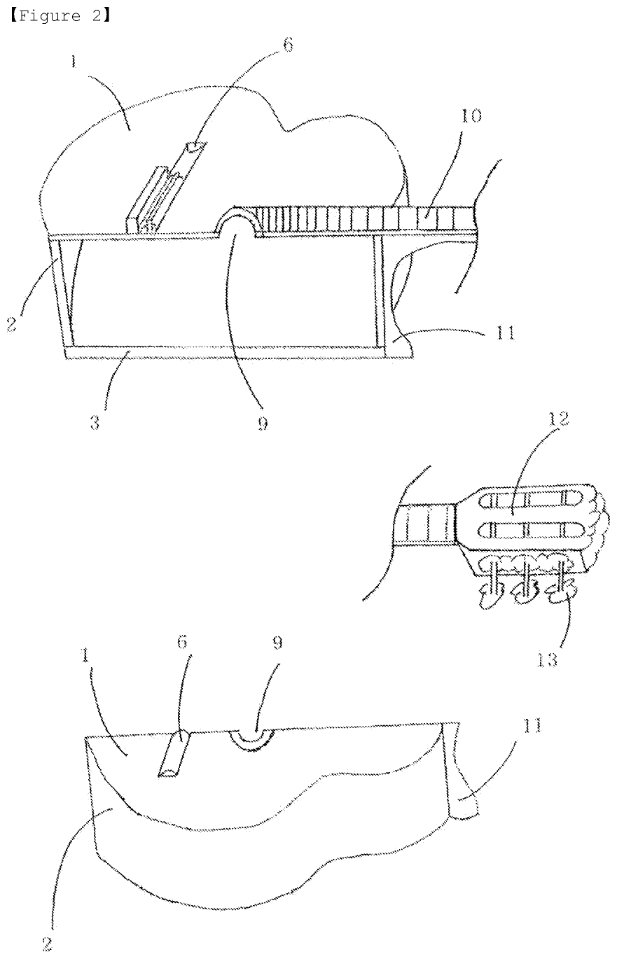

FIG. 3 is a structural cross-sectional view of a musical instrument according to the present invention.

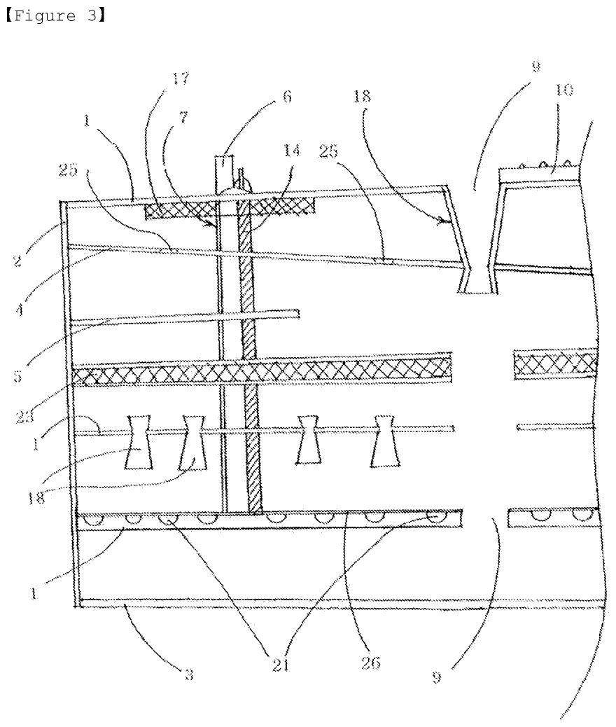

FIG. 4 is a sound waveform view illustrating the principle of stereology of sound.

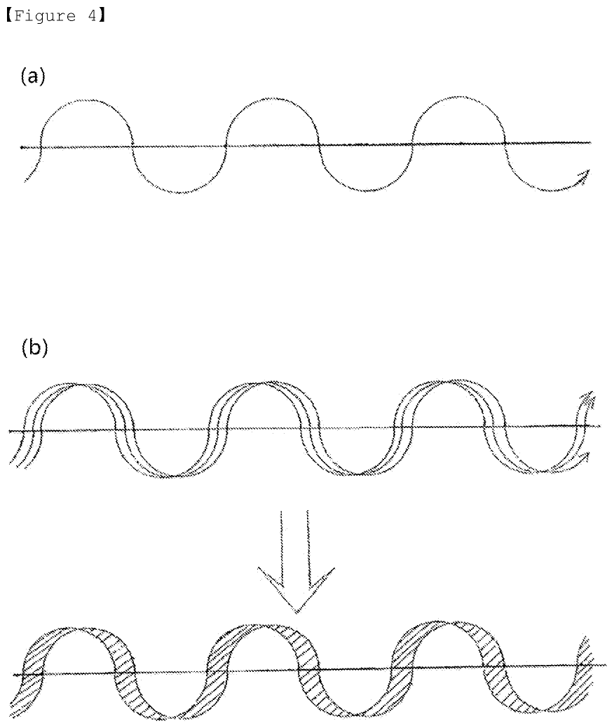

FIG. 5 is a cross-sectional view and a plan view of a three-dimensional bridge 8 with a sound amplifier according to the present invention.

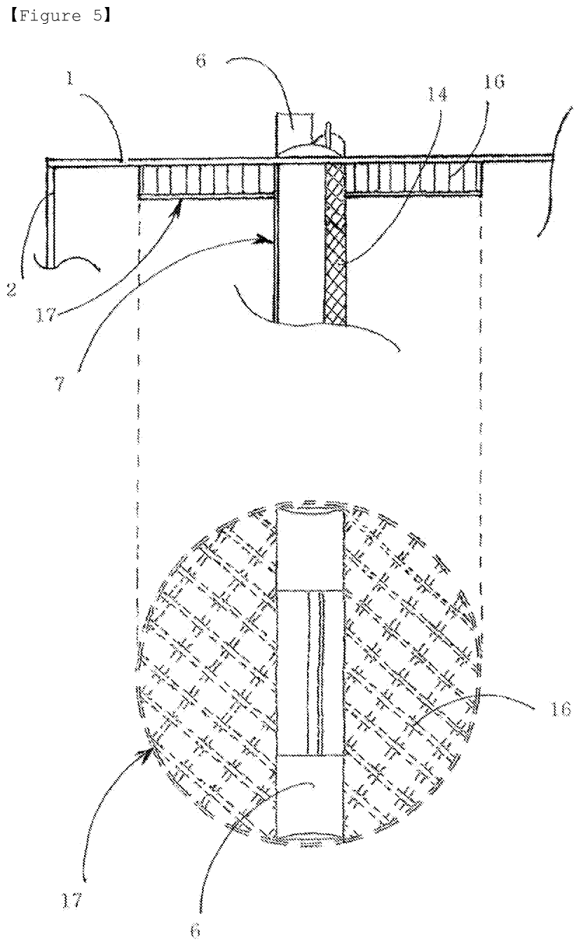

FIG. 6 is view showing an installation position of a sound amplifier 17 according to the present invention in a musical instrument.

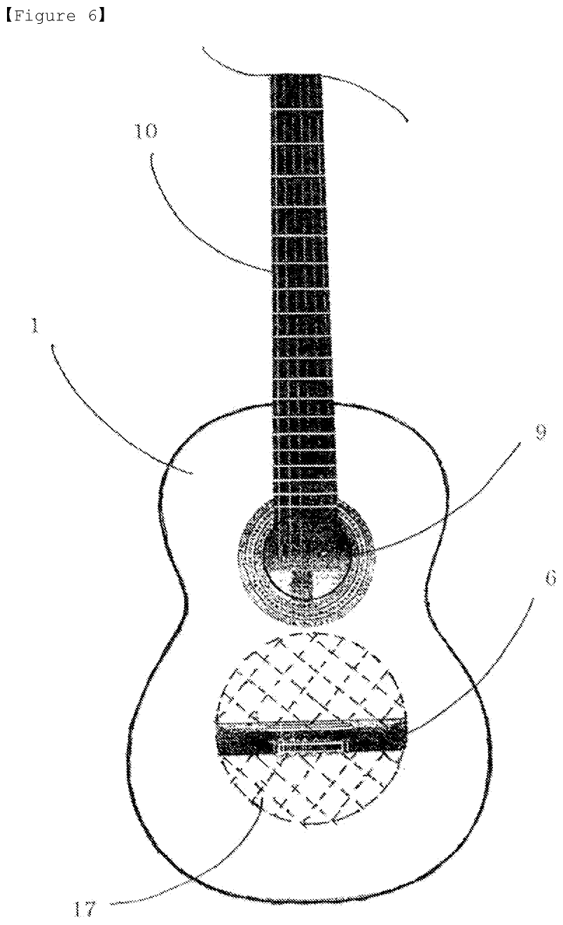

FIG. 7 is a cross-sectional perspective view of a three-dimensional bridge 7 in which the structure of the three-dimensional bridge 7 is enlarged.

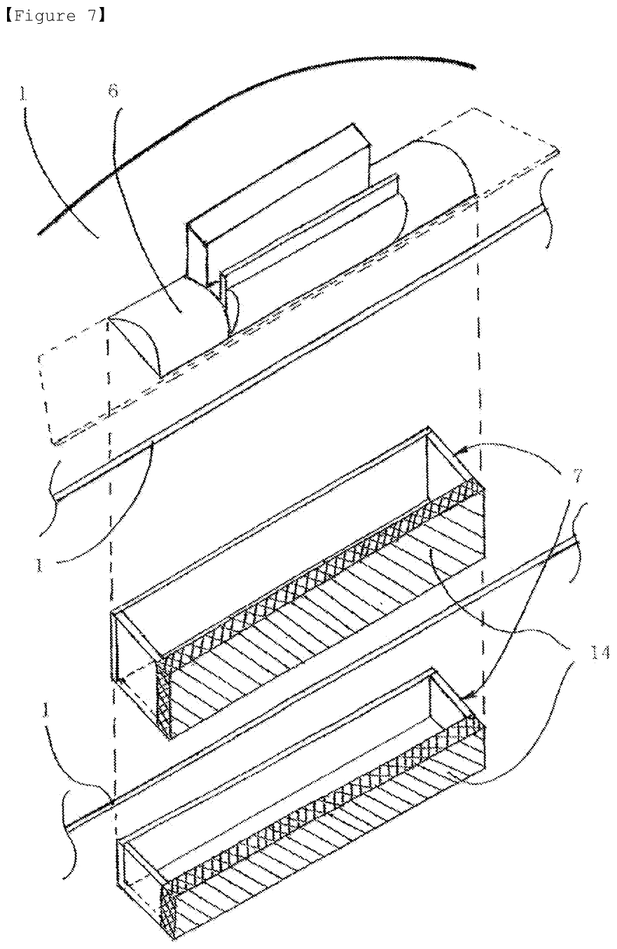

FIG. 8 is a perspective view of a trumpet-type resonance pipe 18 formed in a sound board (A) and a perspective view of a trumpet-type resonance pipe 18 formed in a sound hole 9 (B).

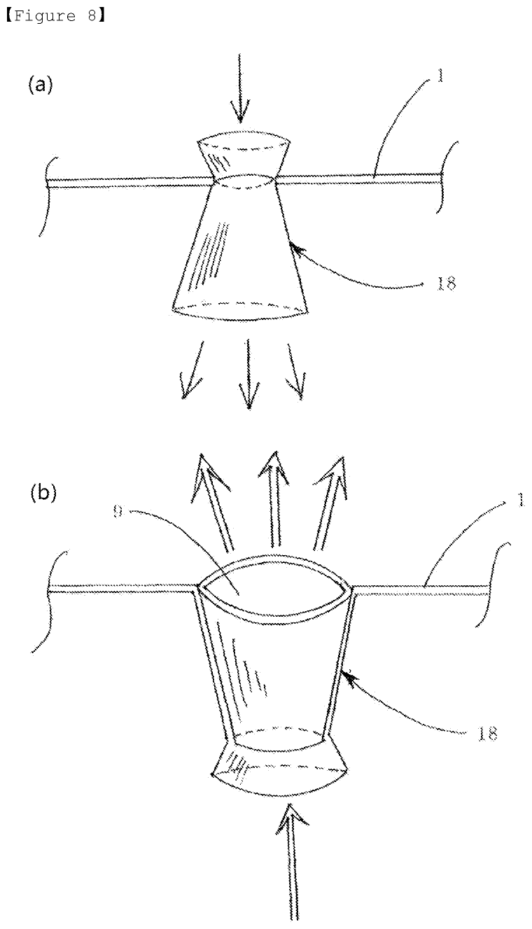

FIG. 9 is a plan view and a cross-sectional view of a groove 21 of a sound board formed in a sound board.

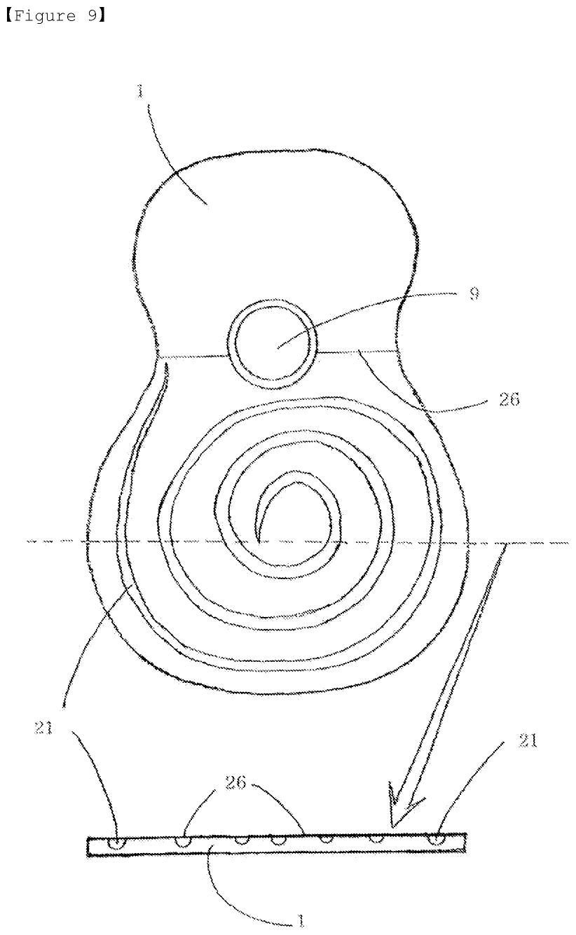

FIG. 10 is a picture showing various types of examples of the groove 21 of a sound board.

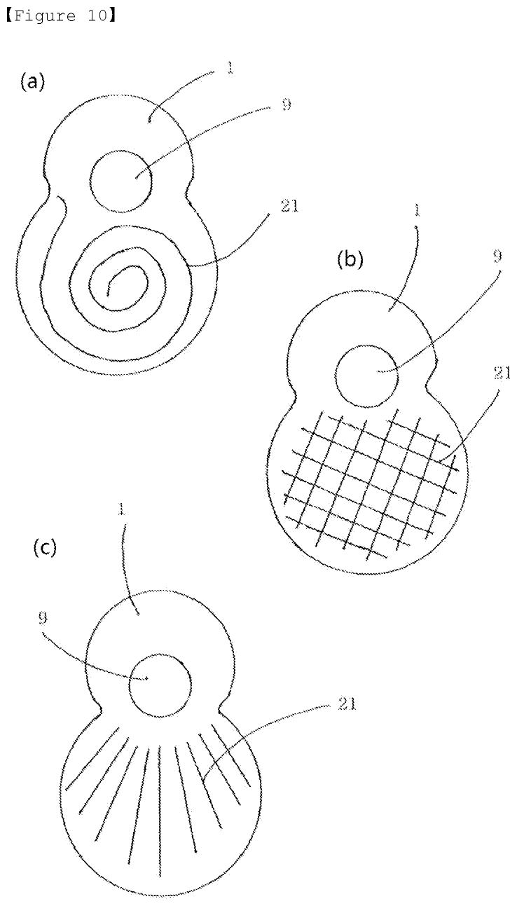

FIG. 11 is a cross-sectional view showing an example of a violin-group instrument according to the present invention.

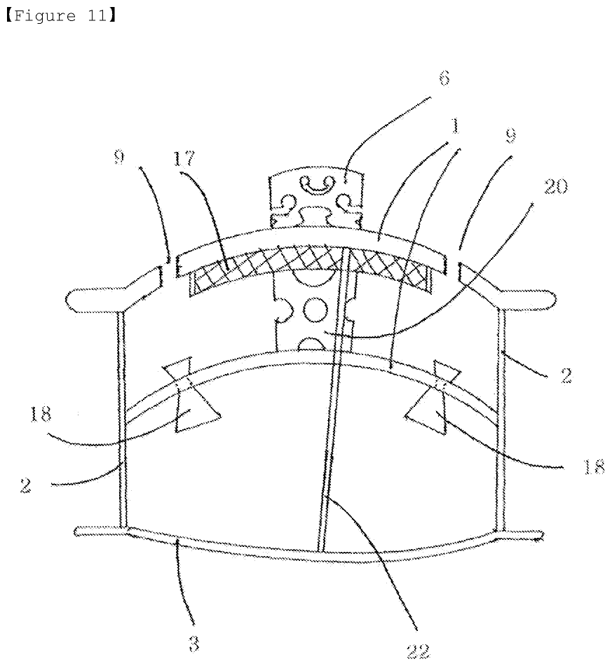

FIG. 12 is a front and rear structural view of an existing piano sound board.

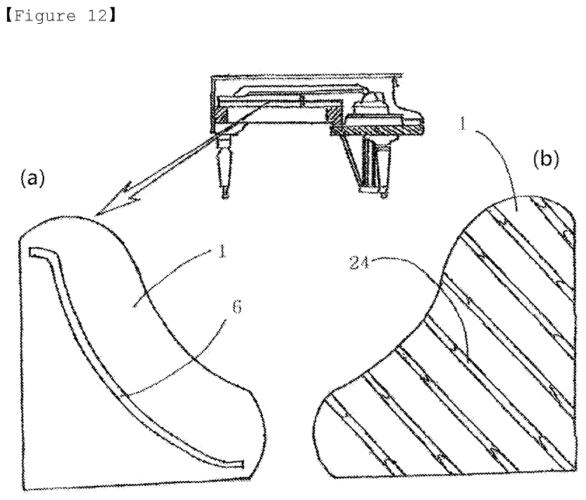

FIG. 13 is a structural view showing a front (A and C) and a rear (B and D) of a piano sound board designed with a plurality of sound boards according to the present invention.

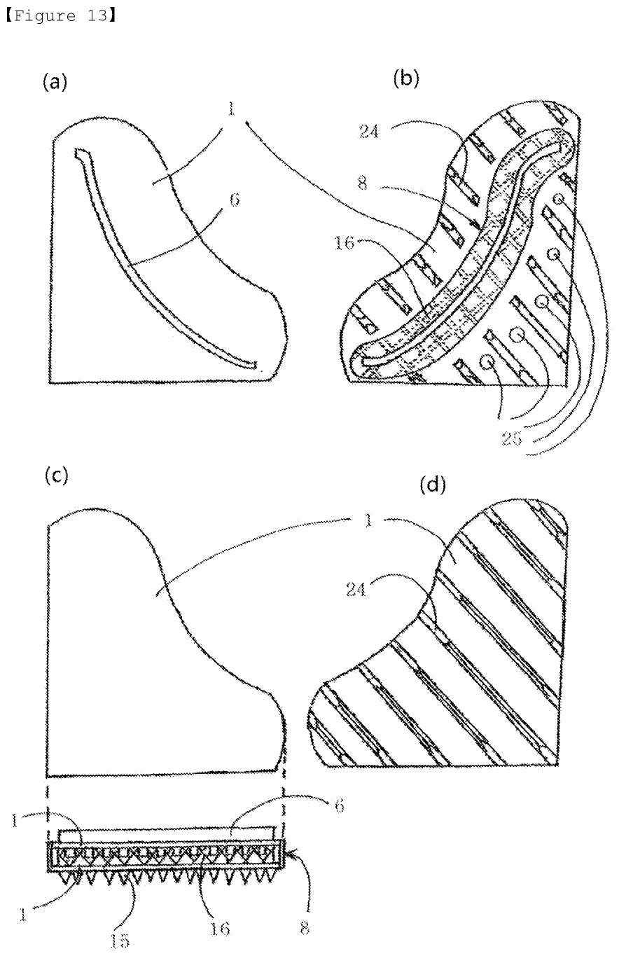

### DESCRIPTION OF REFERENCE NUMERALS

1. sound board

2. side plate

3. rear plate

4. inclined sound board

5. reduced sound board

6. bridge

7. three-dimensional bridge

8. three-dimensional bridge with sound amplifier

9. sound hole

10. fingerboard

11. hill

12: head

13. spool

14. bridge core

15. frame

16. rib

17. sound amplifier

18. trumpet-type resonance pipe

19. neck

20. I-type connection bridge

21. groove of sound board (minus bracing)

22. sound post

23. three-dimensional sound board

24. upper neck

25. sound channel hole

26. cover plate

1. A musical instrument, which is one of musical instruments generating a sound using a sound board, the musical instrument designed to generate resonance of abundant and various sounds by separating a resonance space into several parts by simultaneously using several sound boards to one musical instrument, to enable a magnificent and wide-spectrum performance such as an orchestra as one musical instrument by implementing a high-level sound effect required when playing the musical instrument, such as not only an increase of a volume, but generation of an individual tone, depth of a sound, and a stereoscopic sense of a sound by applying various and new elements to each of several sound boards.

2. The musical instrument of claim 1, wherein an inclined sound board (4) is formed to be inclined rather than parallel with another sound board, so a sound wave smoothly travels and resonates while being mixed well with a sound wave from the another sound board, whereby an individual tone is generated and a sound effect is improved; and the inclined sound board is diagonally formed across a resonance space in the musical instrument, whereby the area of the sound board increases to be able to increase the volume of the musical instrument.

3. The musical instrument of claim 1, wherein a reduced sound board (5) reduced in size by forming a sound board smaller than another sound board rather than the same in size such that a portion of the sound board resonates a sound and the other portion transmits a sound, whereby the flow of a sound wave in the musical instrument is diversified, a tone is changed, and resonance is improved; and the sound board can be easily vibrated because the weight of the sound board is small, thereby being able to make a performance easy.

4. The musical instrument of claim 1, wherein since it is required to maximally amplify and transmit vibration energy of a forward sound board to a next sound board in order to generate sound simultaneously from sound boards through one plucking in a musical instrument designed with several sound boards, partition ribs are disposed inside and are covered with a thin cover plate to seal a space, whereby a sound amplifier having a structure that can increase a resonance effect because the space is divided into several rectangular resonance spaces by the partition ribs; and a three-dimensional bridge (8) with a sound amplifier designed to maximally transmit vibration of an amplified sound to the next sound board without a loss of energy is formed in a sound board to be able to generate a synergy effect when transmitting vibration of a sound by integrating a rectangular three-dimensional bridge that is hollow to reduce weight and is efficient to transmit vibration.

5. The musical instrument of claim 1, wherein a three-dimensional sound board is formed to be able to generate a strong and stereoscopic tone, which is generated from a sound board formed by integrating two sound boards into one sound board using partition ribs, and to be able to a resonance effect and a volume through a set of many rectangular closed resonance spaces formed by the partition ribs.

6. The musical instrument of claim 1, wherein, in a bridge that transmits a sound by connecting a series of sound boards to be able to generate a sound by receiving vibration energy simultaneously from several sound boards, a three-dimensional bridge (7) is formed in a hollow type to reduce weight using a thin and light material to minimize reduction of vibration energy, is formed in a rectangular three-dimensional shape that is efficient to transmit vibration energy, and is continuously formed in a vertical direction on each sound board using a bridge core made of a rigid and light material right under a portion where string are held of a sound board to directly transmit sound vibration.

7. The musical instrument of claim 1, wherein a trumpet-type resonance pipe (18) is formed in a sound board and a sound hole so that a sound wave is enlarged and a volume is increased by diffraction of a sound wave when a sound travels by forming a sound movement pipe like a cone for cheering having a narrow inlet and a wide outlet for a sound in a movement path when a sound resonated in a forward resonance space travels to a next resonance space.

8. The musical instrument of claim 1, wherein a method of attaching a protruding frame to the rear surface of a sound board (bracing) is used for musical instruments generating a sound by employing sound boards in order to tune the musical instruments, but a series of concave grooves is engraved on a sound board and is covered with a thin and light plate, whereby the space is sealed (minus bracing), whereby a groove (21) of a sound board is formed a the edge and the center of a sound board to be able to reduce the weight of the sound board, increase the rigidity, increase the resonance effect, make it possible to easily tune the musical instrument, increase a volume, and make a performance easy.
